(19) United States
(12) Patent Application Publication
(10) Pub. No.: US 2005/0161098 A1
(43) Pub. Date: Jul. 28, 2005

(54) Electromagnetic valve

(76) Inventors: Hubert Ott, Ravensburg (DE); Thomas Grau, Argenbuehl (DE)

Correspondence Address: W. D. Breneman, 3150 Commonwealth Avenue, Alexandria, VA, 22305, US

(21) Appl. No.: 10/505,354

(22) PCT Filed: Feb. 19, 2003
(86) PCT No.: PCT/DE03/00516

(51) Int. Cl. F15B 13/044

(52) U.S. Cl. 137/625.65

(57) ABSTRACT

An electromagnetic valve is proposed that has a compact structural design and is especially convenient to manufacture. This is achieved in a valve with two pole pieces, wherein at least one pole piece is provided with a first fluid line and a first valve seat, and wherein the fluid line is connected by the valve seat with a valve chamber, in which a valve body is arranged so that it can move between at least two switch settings between the valve seat and at least one other stop surface, by having at least one spacer element (15) present in the area of the valve chamber (24) to determine the distance of the valve seat (7) from the other stop surface (8).

The invention relates to an electromagnetic valve according to the preamble of claim 1.

Electromagnetic, in particular bistable, valves are used in a variety of applications, e.g., in fluid circulating systems of household appliances, such as refrigerators and coffeemakers, but also in other areas, e.g., in the area of analytics or medical technology.

In most areas of application, e.g., that of household appliances, preference is here given to valves that have a compact design, and can also be manufactured and assembled with the least possible effort. Various developments have very recently become known for meeting this objective (see DE 199 14 972 A1).

Proceeding from valves according to this prior art, the object of the invention is to propose a valve that is particularly convenient to manufacture.

This object is achieved in a valve according to the preamble of claim 1 by its characterizing features.

The measures specified in the subclaims enable advantageous embodiments and further developments of the invention.

Consequently, a valve according to the invention is characterized in that a spacer element provided in the area of the valve chamber formed between two pole pieces fixes the distance of the structural elements having stop surfaces for the end position of the valve body or a valve seat, e.g., the pole pieces. This distance is of great importance for the functionality of the valve. The precise location of the end positions of the valve body in its various switch settings is important for many valve properties. For example, the starting force of the valve body on the valve seat depends on the location of the valve seat relative to the shape and strength of the magnetic field that holds the valve body on the valve seat. In addition, the distance of the stop surfaces of the valve body in its different switch settings is important, since this influences the acceleration distance, and hence the impact pulse, of the valve body. Accordingly, distance fluctuations can be manifested as differences in noise generation and signs of wear on the valve.

The distance in question is also crucial in terms of the free flow cross section with the valve opened.

A significant production effort has to date been required for keeping allowable tolerances as low as possible with respect to this distance during valve assembly.

Valve assembly is greatly facilitated by the invention through the use of a spacer element placed between the structural elements having the stop surfaces or valve seat for the valve body, e.g., between the two pole pieces in the area of the valve chamber. The two pole pieces or the structural elements having the stop surfaces or the valve seat for the valve body can be joined at the stop using the spacer element, yielding a clearly defined position relative to each other. The tolerance when establishing this distance corresponds to the dimensional tolerance of the spacer element.

In a preferred embodiment of the invention, the two structural elements, which have the stop surfaces, e.g., a valve seat for the valve body, are joined at the stop directly to the spacer element. While additional structural elements can also basically be incorporated in the spacer element, the direct stop at the spacer element precludes other sources of error.

The pole pieces are here preferably designed in such a way with the stop surfaces for the valve body, e.g., a valve seat, that the pole piece assembly yields a dimensionally accurate valve chamber via attachment to the spacer element. In this embodiment, a valve seat for the valve body is preferably incorporated directly into a pole piece, thereby eliminating the need for other potentially error-causing structural components.

The spacer element is preferably designed in such a way as to ensure fluid flow. This ensures a free fluid flow through the valve chamber via the valve seat into a first fluid line serving as the outlet. With the valve open, the passage through the spacer element establishes the connection between this fluid line and a second fluid line correspondingly serving as the inlet line.

Both the first and second fluid lines are preferably incorporated in the two pole pieces as holes, thereby eliminating additional complicated design measures here as well.

In a particularly advantageous embodiment, the external connection of the two fluid lines is established by using conduits at the outlet end of the holes in the pole pieces serving as a fluid line and connecting them there, e.g., via soldering.

In a special embodiment of the invention, the spacer element is designed as a sleeve. This yields a symmetrical stop surface for the structural elements to be joined, e.g., the pole pieces, on the one hand, and a sleeve-shaped spacer element results in a circumferentially good guide on the outer wall of the valve chamber on the other. A sleeve-shaped spacer element is hence effectively fixed in a radial direction after inserted, correspondingly adjusted in the radial direction to the inner contour of the valve chamber.

In a particularly advantageous embodiment, the spacer element is simultaneously provided with guide elements for the valve body. Such guide elements and the resultant good guide for the valve body in its switching motion during valve switchover are associated with several advantages. On the one hand, such guide elements ensure a constant, centric position of the valve body relative to the valve seat. In particular, the valve body impact is centric. An eccentric collision by the valve body with the valve seat had previously been possible, e.g., caused by the fluid, resulting in an elevated wear. In addition, the fact that the valve body is centered during the entire motion makes such a guide element advantageous in terms of noise generation and wear reduction. Such guide elements can also be used to largely preclude a twisting or jamming of the valve body, thereby also yielding a lower noise generation.

In a special embodiment of the invention, in particular in a sleeve-shaped spacer element, the guide elements are designed as inner, radially protruding ribs. Such guide elements can already be molded into the spacer element during its manufacture, thereby eliminating the need for additional structural elements or additional processing steps. This significantly reduces the production effort for this embodiment with guide elements. Further, such guide ribs make it possible to axially guide the valve body over its entire moving length, simultaneously enabling a passage between such ribs for the fluid, and hence a connection between the two fluid lines, without allowing any impairment by the spacer element or guide elements.

The spacer element according to the invention can advantageously be made out of plastic, e.g., via injection molding. This makes the production effort exceedingly low, wherein the valve can conceivably also be easily used for chemically aggressive fluids through the suitable selection of materials for the spacer element.

In a special embodiment of the invention, the spacer element is provided with a filter element. Such a filter element, e.g., designed as a sieve insert, makes it possible to keep dirt particles out of the valve seat and valve body area. This ensures a durable sealing function and compressive strength on the one hand, and a lower wear, and hence increased valve life on the other.

This embodiment is particularly advantageous when used in closed fluid circulating systems, in which the fluid in the closed circulating system is filtered through completely one time, after which dirt loads that can jam the filter element no longer arise. In this embodiment, the filter element must be dimensioned in such a way that it can filter out all dirt particles that might come about during valve assembly or other production processes without significantly impairing filter permeability.

Valve inflow is preferably realized with an eccentrically arranged hole in a pole piece, thereby simultaneously enabling the series-connection of the filter element in proximity to the outer circumference of the valve chamber. In this case, the filter or sieve element can be disk-shaped, e.g., as a ring wheel.

In addition, the valve housing is advantageously designed as a tube, which is to incorporate all essential valve components. In a particularly simple embodiment of the invention, these valve elements are limited to the pole pieces, the spacer element, if necessary with filter, and the valve body.

Such a tube, preferably in the form of a cylindrical tube, can be obtained by simply cutting to length a commercially available tube material, e.g., made of stainless steel, and additionally offers the advantage that it can be inserted into a control coil without any problem due to its cylindrical form.

In order to tightly seal the valve chamber, it is best that the pole pieces be connected with the cylindrical tube after inserted therein, preferably welded, for example in the case of a stainless steel tube. A very tight weld can be established from outside via laser welding. However, other joining methods, e.g., press molding or the like, are also conceivable at this juncture.

A valve according to the invention is preferably designed as a bistable valve, for which at least one permanent magnet, two permanent magnets in the preferred embodiment, are to be provided to hold the valve body in its respectively actuated switch setting via the permanent magnetic field. Both for this purpose and to effect control via an electromagnetic control coil, the valve body is best made at least partially out of magnetic or magnetizable material.

The permanent magnet(s) is/are preferably designed as annular magnets that generate a circumferentially uniformly distributed, rotationally symmetrical magnetic field, and additionally are easy to place in or on a receptacle of correspondingly cylindrical design.

In one special embodiment, each pole piece is for this purpose provided with a corresponding cylindrical projection, onto which an annular magnet can be slipped. This provides for a radial fixation of the permanent magnets. Axial fixation can be initiated by appropriately designing the spacer element or its guide elements, thereby making the overall assembly of even a bistable valve particularly simple. In the described further development of the invention, only the pole pieces, valve body, spacer element, if necessary with integrated filter, and permanent magnets need be inserted into a cylindrical tube and fixed in place by attaching the pole pieces, e.g., by welding.

The unit fabricated in this way can then be inserted as a complete valve unit into a control coil, thereby providing the desired compact overall unit.

The permanent magnets are preferably fixed in place by providing corresponding receptacles in the spacer element to bring about the desired defined position of the permanent magnets by way of a positive connection with the permanent magnets. In a special embodiment, such a receptacle can be provided, for example, in the form of pin or cone-shaped elevations, which ensure a positive connection with the permanent magnets. In addition, the positive connection can be improved by making such a receptacle deformable, in particularly elastically deformable, in design.

Since a partially spherical shape has proven itself for the valve body or valve seat, the preferred embodiment of the invention makes use of a valve body encompassing a ball whose diameter is tailored to a spherical valve seat. Already at a low height of lift for the valve body, the spherical shape of the valve seat and ball already yield an opening gap with a comparatively large cross section.

In a particularly advantageous further development of this embodiment, the selected valve body itself is a ball, preferably a steel ball. This embodiment offers the advantage of a valve body with optimal fit on a spherical valve seat at a very low mass. The low mass ensures a reduced pulse acting on the valve seat while switching the valve, and hence lower wear and less noise generation.

A valve according to the invention can be designed as a so-called 2/2 valve, wherein the described two fluid lines are provided in this case. The two switching states of the valve here define an open valve state, in which the valve body is lifted from the valve seat, thereby interconnecting the two fluid lines. By contrast, in the closed valve state, the valve body sits on the valve seat, thereby interrupting the fluid connection.

A valve according to the invention can also be designed as a 3/2 valve. In this case, a third fluid line and second valve seat must be provided.

In this case, the two outflow lines are preferably attached in the pole pieces via centric holes, wherein a respective valve seat is secured to the pole piece, preferably molded therein, on the side facing the valve body. The centric arrangement of outflow lines permits the centered position of the valve body, and hence a uniform, rotationally symmetrical exposure to annular magnets on the one hand, and the outlying control coil on the other.

An exemplary embodiment of the invention is shown in the drawing, and will be explained in greater detail below based on the figures.

Shown on:

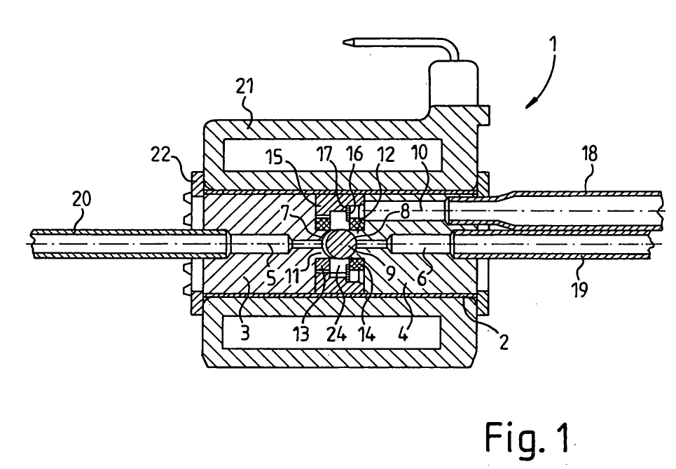

FIG. 1 is a longitudinal section through a 3/2 valve according to the invention, and

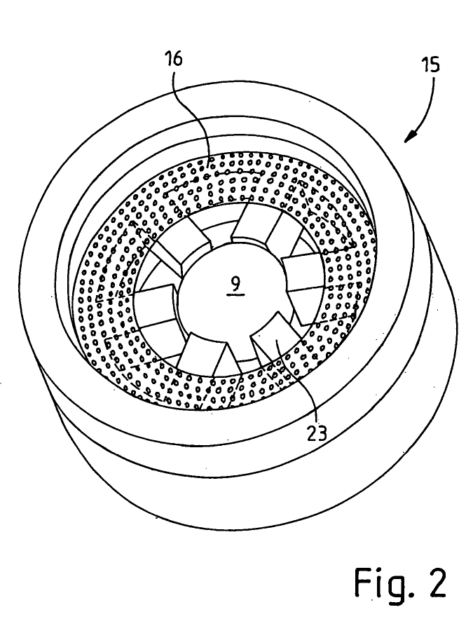

FIG. 2 is a perspective view of a spacer element according to the invention.

Valve 1 encompasses a valve housing 2 designed as a cylindrical tube, into which two pole pieces 3, 4 are inserted. A respective hole 5, 6, each serving as a fluid line, is introduced in pole pieces 3, 4. Fluid lines 5, 6 empty into two valve seats 7, 8, which are spherical, and hence tailored to the shape of a ball-shaped valve body 9. In the switching state shown, valve body 9 closes valve seat 8.

In addition to centric hole 6, pole piece 4 also accommodates another eccentric hole 10, which serves as an inlet for the fluid.

The two pole pieces 3, 4 are provided with cylindrical projections 11, 12 in the form of cross sectionally tapered segments, upon which the two annular magnets 13, 14 are placed. Annular magnets 13, 14 establish a roughly flush seal with pole pieces 3,4 or valve seats 7, 8.

A spacer sleeve 15 according to the invention is inserted between the pole pieces, and thereby precisely defines the distance between pole pieces 3, 4 and valve seats 7, 8. A sieve 16 is designed as a ring wheel, and placed inside spacer sleeve 15, which is provided with a shoulder 17 for this purpose.

Pole pieces 3, 4 are connected with valve housing 2 in a manner not shown in any greater detail, welded in the stainless steel version, preferably laser-welded from outside.

Connecting tubes 18, 19, 20 are inserted in holes 5, 6 and 10, which are widened somewhat at the end for this purpose. Connecting tubes-18, 1-9, 20 are tightly connected with pole pieces 3, 4, e.g., soldered.

The entire valve is placed in a control coil 21, and fixed on the end via a yoke plate 22, which can be a box-type yoke or U-shaped, by abutting valve housing 2 and parts of pole pieces 3, 4 with yoke plate 22.

The valve is conceptually simple to assemble. The different valve components, i.e., pole pieces 3, 4, valve body 9 with annular magnets 13, 14 secured thereto, and spacer sleeve 15 are positively introduced into the housing and welded therein. Connecting tubes 18, 19, 20 are preferably secured in pole pieces 3, 4 prior to welding. As a result, the valve is completed, and its assembly only involves placing it in control coil 21, and fixing it in place with yoke plate 22.

The perspective view of spacer sleeve 15 with incorporated valve body 9 according to FIG. 2 depicts guide ribs 23, which protrude radially inward, and guide the ball that forms valve body 9 along the valve axis in its linear movement. Also visible in this view is sieve 16, which is placed in spacer sleeve 15. Guide ribs 23 simultaneously form a passage for the fluid streaming from the eccentric hole 10 serving as an inlet in pole piece 4 into valve chamber 24, which incorporates valve body 9. As a result, guide ribs 23 also ensure passage to outlets 5, 6 via valve seats 7, 8, depending on the switch setting of the valve. In this case, annular magnet 14 internally seals off the inlet 10 in the area of sieve 16, thereby ensuring that the fluid must pass through sieve 16 from hole 10 to get inside valve chamber 24.

The spacer sleeve 15 carrying sieve 16 is used for precisely setting the distance of pole pieces 3, 4 or their valve seats 7, 8 on the one hand, and ensures that ball-shaped valve body 9 is axially well guided via guide ribs 23. Use of spacer sleeve 15 greatly facilitates assembly. Guide ribs 23 reduce the noise level during valve operation.

In addition, due to the ball-shaped design of valve body 9 and corresponding spherical shape of valve seats 7, 8, this embodiment requires only a slight switching path of valve body 9 to generate a gap between valve seat 7 or 8 and valve body 9, which provides a sufficient flow cross section.

The short switching paths of valve body 9 in turn reduce noise generation. Securing the annular magnets in direct proximity to the valve seat permits smaller dimensions for the latter, while still generating a sufficiently high contact force of valve body 9 on the respective valve seat 7, 8.

The ball shape additionally enables the use of a valve body 9 with a very low mass, thereby distinctly reducing noise generation and wear during impact on the respective valve seat 7, 8. This also facilitates the manufacture of valve seats 7, 8, since the latter can have a lower hardness. In addition, inexpensive steel balls of sufficient quality are available on the market.

Sieve 16 ensures that no dirt particles can get in the area of valve seats 7, 8, resulting in improved sealing function and reducing wear. In addition, magnetic or magnetizable particles from the streaming fluid are also retained on the permanent magnet 14 positioned in the flow.

Annular magnets 13, 14 yield a valve with a bistable design. Suitable permanent magnets can be used to fabricate valves with enough chemical and thermal resistance to enable operation even under severe conditions, e.g., at high temperatures or with chemically aggressive fluids. In this bistable embodiment, the switch position can be changed with only a short control pulse via control coil 21 to change the switch setting, so that valve 1 as a whole not only forms a compact valve unit that can be manufactured at low cost, but also yields very high energy savings.

Reference List:
1 Valve
2 Valve housing
3 Pole piece
4 Pole piece
5 Hole
6 Hole
7 Valve seat
8 Valve seat
9 Valve body
10 Hole
11 Projection
12 Projection
13 Annular magnet
14 Annular magnet
15 Spacer sleeve
16 Sieve
17 Shoulder
18 Connecting tube
19 Connecting tube
20 Connecting tube
21 Control coil
22 Yoke plate
23 Guide ribs
24 Valve chamber

1. Valve with two pole pieces, wherein at least one pole piece is provided with a first fluid line and a first valve seat, and wherein the fluid line is connected by the valve seat with a valve chamber, in which a valve body can be moved between at least two switch settings between the valve seat and at least one other stop surface, characterized in that at least one spacer element (15) is present in the area of the valve chamber (24), which determines the distance of the valve seat (7) from the other stop surface (8).

2. Valve according to claim 1, characterized in that the valve seat (7) and additional stop surface (8) are molded into a respective pole piece (3, 4), and the pole pieces (3, 4) are secured directly to the spacer element (15).

3. Valve according to one of the preceding claims, characterized in that the spacer element (15) has a fluid passage.

4. Valve according to one of the preceding claims, characterized in that the outer connecting tubes (18, 19, 20) are secured in at least one pole piece (3, 4) to carry fluid.

5. Valve according to one of the preceding claims, characterized in that the spacer element (15) is sleeve-shaped.

6. Valve according to one of the preceding claims, characterized in that the spacer element (15) encompasses guide elements (23) for the valve body (9).

7. Valve according to one of the preceding claims, characterized in that the guide element (23) is designed as inner radial ribs on the spacer element (15).

8. Valve according to one of the preceding claims, characterized in that the spacer element (15) is made at least partially of plastic.

9. Valve according to one of the preceding claims, characterized in that the spacer element (15) is provided with a filter element (16).

10. Valve according to one of the preceding claims, characterized in that the second fluid line (10) is designed as an eccentric hole in a pole piece (4).

11. Valve according to one of the preceding claims, characterized in that the pole pieces (3, 4) and spacer element (15) are incorporated in a tubular valve housing (2).

12. Valve according to one of the preceding claims, characterized in that at least one permanent magnet (13, 14) is provided.

13. Valve according to one of the preceding claims, characterized in that the permanent magnet (13, 14) is arranged inside the tubular valve housing (2).

14. Valve according to one of the preceding claims, characterized in that the permanent magnet (13, 14) is designed as an annular magnet.

15. Valve according to one of the preceding claims, characterized in that the permanent magnet (13, 14) is placed on a projection (11, 12) of a pole piece (3, 4) formed by a cross sectionally tapered segment.

16. Valve according to one of the preceding claims, characterized in that the spacer element (15) is provided with a receptacle for a permanent magnet (13, 14).

17. Valve according to claim 16, characterized in that the receptacle encompasses elevations, which bring about a positive connection between the spacer element (15) and at least one permanent magnet.

18. Valve according to claim 17, characterized in that the elevations are deformable.

19. Valve according to claim 17 or 18, characterized in that the elevations are elastic.

20. Valve according to one of the preceding claims, characterized in that the tubular valve housing (2) is incorporated in a control coil (21).

21. Valve according to one of the preceding claims, characterized in that the valve body (9) encompasses a ball, and the valve seat (7, 8) is at least partially spherical.

22. Valve according to one of the preceding claims, characterized in that the valve body (9) is a ball.

23. Valve according to one of the preceding claims, characterized in that a third fluid line (6) and a second valve seat (8) are provided to create a so-called 3/2 valve.
